(19) United States
(12) Patent Application Publication
(10) Pub. No.: US 2008/0084488 A1
(43) Pub. Date: Apr. 10, 2008

(54) Digital photographing apparatus and method for detecting and correcting smear by using the same

(75) Inventors: Han-Sang Kim, Suwon-si (KR); Bong-Gon Kim, Seoul (KR); Chan-Yul Kim, Bucheon-si (KR); Young-Hun Joo, Yongin-si (KR)

Correspondence Address: CHA & REITER, LLC, 210 ROUTE 4 EAST STE 103, PARAMUS, NJ, 07652, US

(73) Assignee: Samsung Electronics Co., Ltd.

(21) Appl. No.: 11/973,510

(22) Filed: Oct. 9, 2007

(30) Foreign Application Priority Data
Oct. 10, 2006 (KR) 98445/2006

(51) Int. Cl. H04N 9/64; H04N 5/228; H04N 5/335

(52) U.S. Cl. 348/249; 348/222.1; 348/311; 348/E05.031; 348/E05.091; 348/E09.037

(57) ABSTRACT

Disclosed is a digital photographing apparatus which includes a lens for optically photographing an object, a CCD for performing photoelectric conversion for an image photographed by the lens, a buffer unit for storing the image converted by the CCD in a unit of frame or field, a controller for determining if a smear has occurred in the image output from the buffer unit, and correcting a pixel value of an image area in which the smear has occurred, an image processor for compressing the image output from the CCD by using a scheme according to characteristics and sizes of a display unit, or restoring the compressed image into an original image under the control of the controller and the display unit for displaying the image output from the image processor on a screen.

### CLAIM OF PRIORITY

This application claims the benefit of the earlier filing date, pursuant to 35 USC 119, to that patent application entitled “Digital Photographing Apparatus And Method For Detecting And Correcting Smear By Using The Same,” filed in the Korean Intellectual Property Office on Oct. 10, 2006 and assigned Serial No. 2006-98445, the contents of which are hereby incorporated by reference.

### BACKGROUND OF THE INVENTION

1. Field of the Invention

The present invention relates to a digital photographing apparatus and more specifically a method and apparatus for detecting and correcting smear.

2. Description of the Related Art

In an existing camera, a photograph cannot be obtained before the image of an object through a lens is exposed to a film, and developed and printed. In a digital camera, an image is formed in a Charged Coupled Device (CCD), etc., instead of a film. In this case, image signals are converted into digital data, and the digital data is stored in a memory in the form of image data. Then, the image data stored in the memory is presented through a Display (e.g., LCD), and various material processing operations including edition, output, etc., are performed using a computer, etc. When the materials are required, easy output is possible because development and print processes are not performed.

Hereinafter, a camera using a film and a digital camera having other characteristics will be described. A digital camera can view an image through a LCD installed therein, instantly confirm the photographed image, and cancel the photographed image or photograph a second image. Further, it is possible to subdivide the image photographed and view the subdivided images via the LCD.

The storage device of a digital camera typically is a flash memory card, smart media, compact flash, memory sticks, etc., and shows the tendency of miniaturization and higher capacity. Moreover, the storage device is detachable, and is advantageous in terms of transmission speed, portability and convenience of storage. Images can easily and rapidly transmit data to a computer through a Universal Serial Bus (USB) reader, a flash pass (a secondary reader through a floppy disk), etc.

Further, since a photographed image is stored as a predetermined image format, i.e. a Joint Photographic Experts Group (JPEG), a Tagged Image File Format (TIFF), etc., a user can easily utilize or apply the image by using any software, and obtain a photograph of high picture quality as an output. Furthermore, a user can easily edit the image through dedicated digital camera software. In addition, it is possible to transfer photographed image data to a PC, a Macintosh, etc., through a cable, and to obtain photographs of various sizes through a dedicated digital printer, an inkjet printer, etc.

As described above, a digital camera provides convenient functions while overcoming the disadvantages of an existing general optical camera, and combining various advantages with a digital scheme, so that users and use range are being increasingly spread.

From among the characteristics of a digital camera, generation and processing of an image exhibit characteristics different from those of an existing general optical camera. The CCD of a digital camera converts optical signals into electrical signals, and includes numerous photoelectric elements which are referred to as pixels. The size and the number of pixels of a CCD are important factors for determining the resolution of a digital camera.

Further, the quality of an image is determined according to specifications of a lens, a shutter, an analog digital converter, etc. Herein, the resolution of a digital camera is expressed by the multiplication and size of the number of lateral pixels and the number of longitudinal pixels, e.g. by 1024×768, 2M, etc., and is used as a basic unit constituting an image in a computer. In other words, if the number of pixels is high, it represents high resolution. If the number of pixels is low, it represents low resolution. When an image is output to a monitor or a printer, resolution is used as a criterion determining the quality of the image. The pixel is used for a device recording or displaying an image in a digital manner. In a digital camera, when a camera shutter button operates, light is instantaneously received in corresponding pixels, respectively, and the light in the pixel is collected to form a single image.

FIG. 1 is a diagram illustrating a smear occurring when photographing light of strong intensity when using a general CCD camera.

When the CCD camera photographs strong reflection light, such as a headlight or the sun, a smear, in which a vertical line extending from a first line at the bottom edge of the illustrated photograph to a last line (in this case the top edge of the illustrated photograph) appears on a screen, occurs as illustrated in FIG. 1.

The smear occurs when using a high speed shutter, which frequently occurs when photographing a very bright object such as the sun. This is caused by an overflow of the amount of charges, which can be stored in one cell, due to inter-cell reflection and interference, etc, even though one light must be received in one cell of a CCD. It may be similar to blooming, but the smear is different from blooming. That is, in blooming, light is spread in a round shape. In the smear, overflowed charges form a straight line.

Since such a smear corresponds to a structural problem in which it occurs only in a CCD camera, it is unavoidable in a camera employing a CCD. A case of photographing a light source does not frequently occur, but a smear may occur even in an unexpected situation due to the sun reflected by glass. That is, in terms of the structure of a CCD camera, when photographing an object (headlight, fluorescent lamp, sun, strong reflected light) of high luminance, a line in a vertical direction appears on a screen and has influence on adjacent pixels. Therefore, objects around a light source are not seen.

### SUMMARY OF THE INVENTION

Accordingly, the present invention has been made to solve the above-mentioned problems occurring in the prior art, and it is an aspect of the present invention to detect a smear which is the characteristic of a CCD camera and is unavoidable by hardware.

It is another aspect of the present invention a smear is corrected by using adjacent pixels values for an area in which the smear has occurred.

In accordance with one aspect of the present invention, there is provided a digital photographing apparatus including a lens for optically photographing an object, a CCD for performing photoelectric conversion for an image photographed by the lens, a buffer unit for storing the image converted by the CCD in a unit of frame or field, a controller for determining if a smear has occurred in the image output from the buffer unit, and correcting a pixel value of an image area in which the smear has occurred, an image processor for compressing the image output from the CCD by using a preset scheme according to characteristics and sizes of a display unit, or restoring the compressed image into an original image under the control of the controller and the display unit for displaying the image output from the image processor on a screen.

### BRIEF DESCRIPTION OF THE DRAWINGS

The patent application file contains at least one drawing executed in color. Copies of this patent application publication with color drawing(s) will be provided by the Office upon request and payment of the necessary fee.

FIG. 1 is a diagram illustrating a smear occurring when photographing light of strong intensity when using a general CCD camera;

FIG. 2 is a block diagram illustrating the construction of a digital photographing apparatus according to an embodiment of the present invention;

FIG. 3 is a flow diagram illustrating image detection by a digital photographing apparatus according to an embodiment of the present invention;

FIG. 4 is an exemplary diagram illustrating image detection by a digital photographing apparatus according to an embodiment of the present invention;

FIG. 5 is a flow diagram illustrating image correction by a digital photographing apparatus according to an embodiment of the present invention;

FIG. 6 is an exemplary diagram illustrating image correction by a digital photographing apparatus according to an embodiment of the present invention; and

FIG. 7 is an exemplary diagram illustrating an image corrected by a digital photographing apparatus according to an embodiment of the present invention.

### DETAILED DESCRIPTION OF THE INVENTION

Embodiments of the present invention will be described in detail herein below with reference to the accompanying drawings. For the purposes of clarity and simplicity, a detailed description of known functions and configurations incorporated herein will be omitted as it may obscure the subject matter of the present invention.

An apparatus for photographing a digital image according to the present invention includes a digital camera, a Personal Digital Assistant (PDA), a smart phone, a Portable Multimedia Player (PMP), a camcorder, other mobile communication terminals, etc.

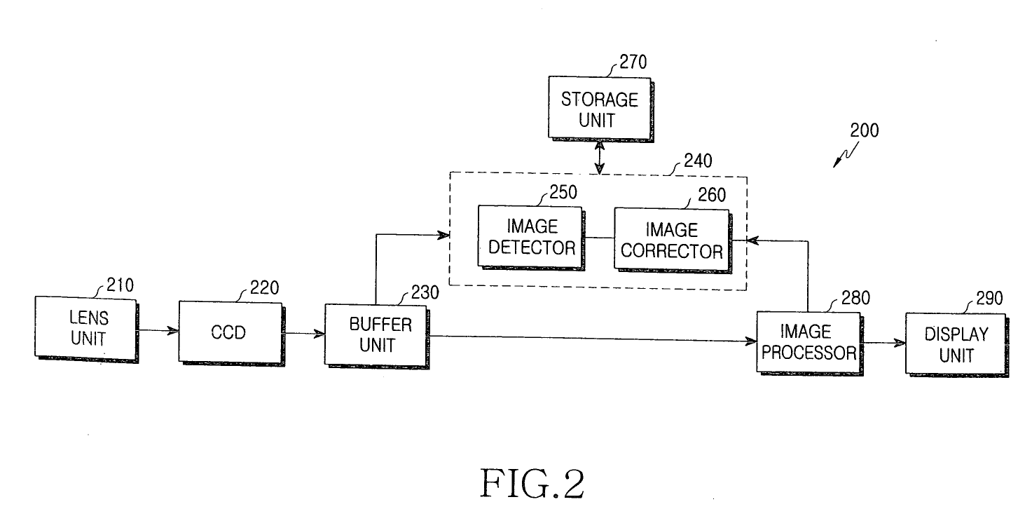

FIG. 2 is a block diagram illustrating the construction of a digital photographing apparatus according to an embodiment of the present invention.

As illustrated in FIG. 2, the digital photographing apparatus 200 of the present invention includes a lens unit 210, a CCD 220, a buffer unit 230, a controller 240, a storage unit 270, an image processor 280 and a display unit 290.

The lens unit 210 includes a plurality of lenses in order to optically project an object. Further, the lens unit 210 includes a zoom lens for enlarging and reducing a magnification of an object, a focus lens for matching the focus of the object, an iris for adjusting the amount of light, etc.

The CCD 220 is used as an imaging device, and converts an image photographed through the lens unit 210 into electrical signals by using a mosaic color filter array scheme.

The digital photographing apparatus 200 uses a mosaic color filter array scheme. That is, an image sensor such as the CCD 220 basically measures only the brightness of light, uses a color filter array for expression of a color tone, and allocates one color tone to each pixel.

Accordingly, it is necessary to compute color data, which does not spatially exist, for an output image of the CCD 220 by using color information of adjacent pixels. This will be referred to as color interpolation or color demosaicing algorithm.

The buffer unit 230 temporarily stores an image converted by the CCD 220 by the frame or field.

The controller 240 controls the general operation of the digital photographing apparatus 200 according to the embodiment of the present invention, determines if a smear has occurred for the image output from the buffer unit 230, and corrects a pixel value of an image area in which the smear has occurred. Further, the controller 240 includes an image detector 250 and an image corrector 260.

The storage unit 270 may include a program memory and a data memory, and stores various information necessary for controlling the operation of the digital photographing apparatus 200, and various information selected based on user selection information. The storage unit 270 may store programs for controlling the lens unit 210 including a camera lens module in a camera mode (i.e. image photographing mode).

The image processor 280 compresses the image output from the CCD 220 by using a scheme according to the characteristics and sizes of the display unit 290, or restores the compressed image into the original image under the control of the controller 240.

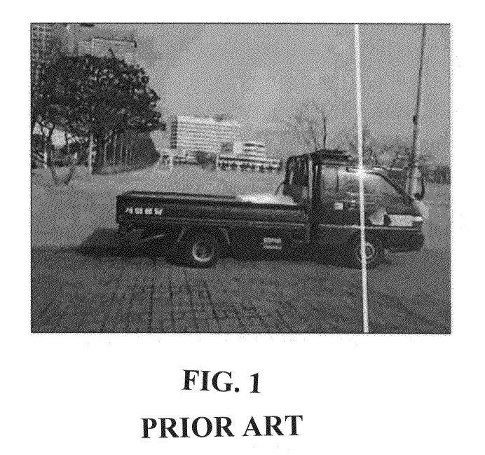

The display unit 290 displays the image output from the image processor 280 on a screen, and displays user data output from the controller 240. It is preferred that the display unit 290 displays various display data generated from the digital photographing apparatus 200, and includes a LCD capable of sufficiently supporting the resolution of an image output from the digital photographing apparatus 200. Hereinafter, a smear in which a light pink color band has occurred in a vertical direction as illustrated in FIG. 1 will be mainly described. The present invention can also be applied to a case in which the light pink color band has occurred in a horizontal direction. Furthermore, although the smear is described with regard to a light pink color, it would be recognized that the smear may be composed of any color and that the principles of the invention described herein are applicable to such smears and considered to be within the scope of the invention.

According to the digital photographing apparatus 200 of the present invention, the CCD 220 converts an image photographed through the lens unit 210 into electrical signals by using a mosaic color filter array scheme.

The controller 240 controls the image processor 280 to compress the image output from the buffer unit 230 by using a scheme according to the characteristics and sizes of the display unit 290, or to restore the compressed image into the original image

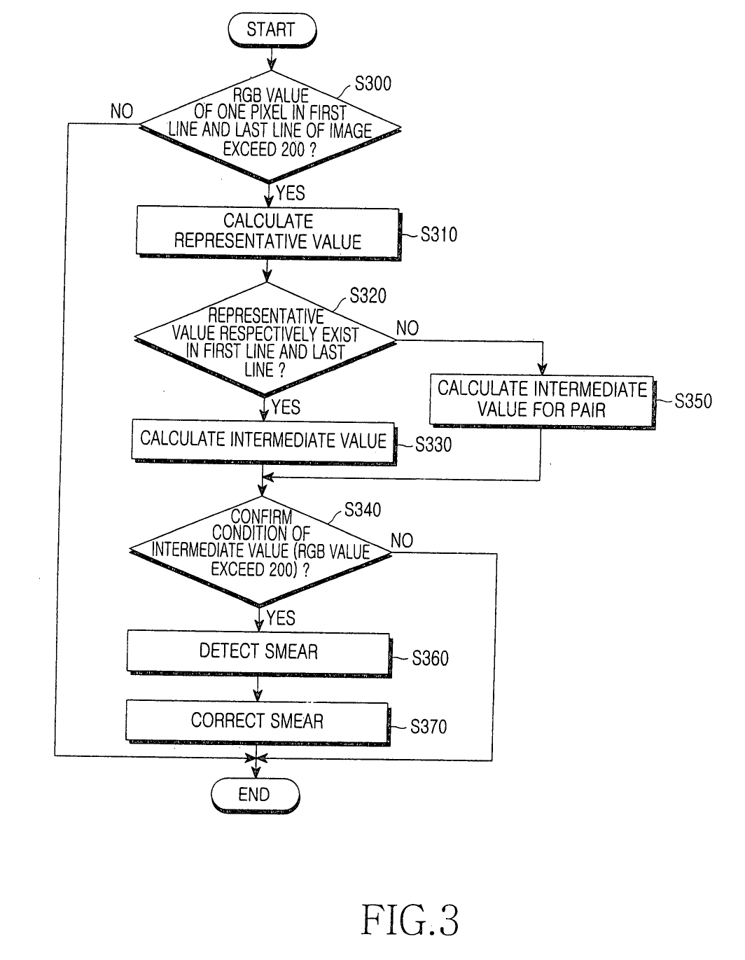

Since a smear always occurs, i.e. a light pink color band appears around a light source up to the boundary of an image in a straight line, the controller 240 determines if the smear has occurred in the image output from the buffer unit 230, and executes an algorithm for finding an area in which the smear has occurred as illustrated in FIG. 3.

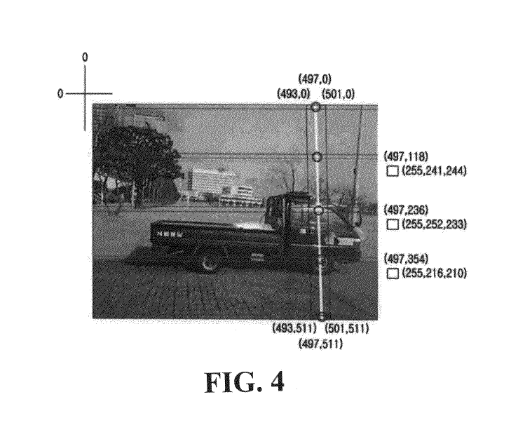

FIG. 3 is a flow diagram illustrating image detection by the digital photographing apparatus according to the embodiment of the present invention, and FIG. 4 is an exemplary diagram illustrating image detection by the digital photographing apparatus according to the embodiment of the present invention.

As illustrated in FIGS. 3 and 4, the image detector 250 of the digital photographing apparatus 200 searches for cases in which RGB values of one pixel in the first line and the last line of the image output from the buffer unit 230 exceed a known value (for example, 200) (S300). The representative values of an area of pixels satisfying the above condition are set as the average value of adjacent RGB pixel values in an x axis of the pixel satisfying the condition (S310).

If the representative values respectively exist in the first line and the last line (S320), an intermediate value connecting the two representative values is calculated on a straight line (S330). Herein, pixel values of three points (¼, 2/4 and ¾ distances along the straight line between the first and last pixel) are calculated, and all RGB values of the corresponding pixel values exceed the known value (S340).

If two or more representative values exist in the first line and the last line (S320), an intermediate value is calculated for each pair, and conditions are verified (S350).

Referring to FIG. 4, the representative value in the first line is (497, 0), the representative value in the last line is (497, 511), three intermediate values calculated using the representative values are (497, 118), (497, 236) and (497, 354), and the RGB values of these intermediate values (255, 241, 244), (255, 252, 233) and (255, 216, 210) which all exceed the known value.

Accordingly, the image detector can determine if a smear has occurred (S360). Then, if all RGB values of the corresponding pixel exceed 200, for example, correction is performed (S370).

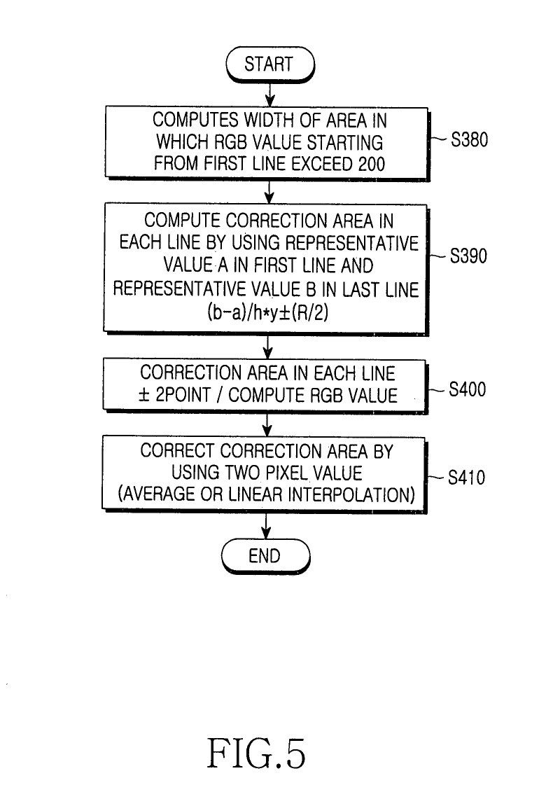

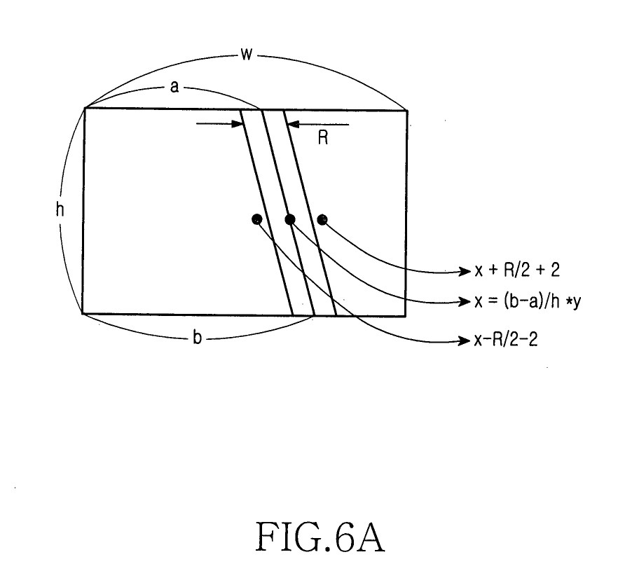

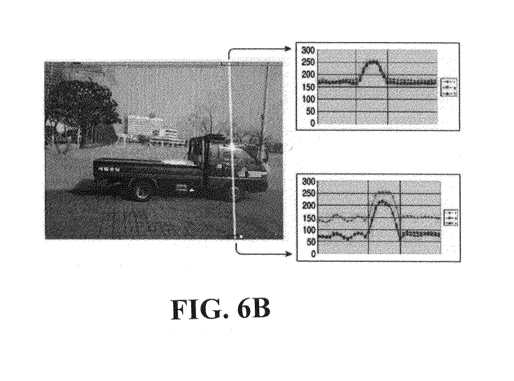

FIG. 5 is a flow diagram illustrating image correction by the digital photographing apparatus according to the embodiment of the present invention, and FIG. 6 is an exemplary diagram illustrating image correction by the digital photographing apparatus according to the embodiment of the present invention.

Hereinafter, an algorithm for correcting pixel values of an area in which a smear has occurred will be described with reference to FIGS. 5 and 6. The image corrector 260 of the digital photographing apparatus 200 computes the number (area) of pixels in which all RGB values, starting from the first line, exceed the known value, i.e. a width (S480). A scheme for computing a correction area in each line by using the representative value “a” in the first line and the representative value “b” in the last line calculated through the above algorithm by which the image detector determines correction or non-correction is as illustrated in FIG. 6A (S490). That is, if an image has lateral and longitudinal lengths of “w” and “h,” respectively, and a current line is a y^{th} line, a value in an x axis of a correction area is calculated by Equation 1 as.

(((b−a)/h)*y)−(R/2)<=x<(((b−a)/h)*y)+(R/2) [1]
wherein “a” represents a pixel RGB value in a first line;
   “b” represents a pixel RGB value in a last line;
   “w” represents a lateral width of an image;
   “h” represents a longitudinal length of an image; and
   “R” represents the width, in pixels, of the area of the smear area.

As it can be seen from the graph of RGB values in FIG. 6B, since an adjacent pixel in which all RGB values exceed 200, for example, has a value slightly greater than adjacent values due to the smear, a reference pixel for correction uses values of pixels apart from the correction area by a second pixel right and left of the smear area (S500).

Then, values in the correction area are altered using the second left and right pixel values. Herein, correction can be performed using various interpolation methods including an average of the two pixel values, linear interpolation, etc. (S510). In the embodiment of the present invention, an average value of two pixels is used to describe the principles of the invention. However, it would be recognized that the invention described herein is not limited to only the described embodiment.

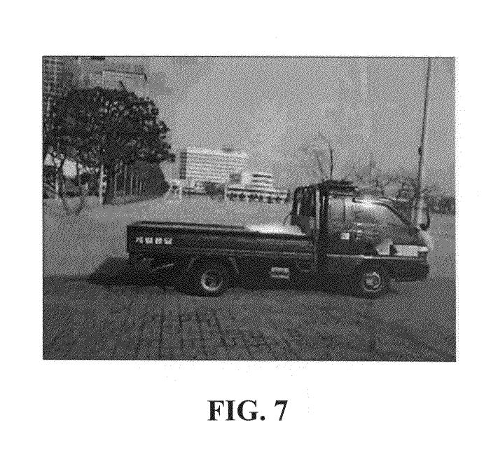

FIG. 7 is an exemplary diagram illustrating an image corrected by the digital photographing apparatus according to the embodiment of the present invention.

As described above, the present invention can detect the occurrence of a smear, which is the characteristic of a CCD camera and is unavoidable by hardware, and corrects an image by using adjacent pixel values for an area in which the smear has occurred, thereby alleviating the distortion of the image.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although an exemplary embodiment of the present invention has been described for illustrative purposes, those skilled in the art will appreciate that various modifications, additions and substitutions are possible, without departing from the scope and spirit of the present invention as disclosed in the accompanying claims, including the full scope of equivalents thereof.

What is claimed is:

1. A digital photographing apparatus comprising:
a lens for optically photographing an object;
a CCD for performing photoelectric conversion of an image photographed by the lens;
a buffer unit for storing the image converted by the CCD in a unit of frame or field;
a controller for determining if a smear has occurred in the image output from the buffer unit, and correcting at least one pixel value of an image area in which the smear has occurred;
an image processor for compressing the image output from the CCD by using a scheme according to characteristics and sizes of a display unit, or restoring the compressed image into an original image under the control of the controller; and
the display unit for displaying the image output from the image processor on a screen.

2. The digital photographing apparatus as claimed in claim 1, wherein the controller further comprises:
an image detector for:
searching for conditions in which RGB values of a pixel in a first line and in a last line of the image output from the buffer unit exceed a known value,
calculating representative RGB values in the smear as an average value of RGB values in an x axis of a pixel satisfying the conditions,
calculating an intermediate value along a straight line connecting the representative values if the representative values respectively exist in the first line and the last line, and
determining if a smear has occurred when RGB values of a corresponding pixel exceed the known value as a result of calculation of the pixel value on the straight line.

3. The digital photographing apparatus as claimed in claim 2, wherein the controller further comprises:
an image corrector for:
computing a width of area in which all RGB values starting from the first line of the image including the smear exceed the known value,
computing a smear correction area from the representative value in the first line and the representative value in the last line,
computing an RGB pixel value from pixels, one right and one left of the smear area,
altering values of the correction area by using an average value of the right/left pixels, and
correcting the image in which the smear has occurred.

4. The digital photographing apparatus as claimed in claim 3, wherein the correction area is determined as:
(b−a)/h*y−(R/2)<=x<(b−a)/h*y+(R/2).

5. The digital photographing apparatus as claimed in claim 1, wherein the display unit displays user data output from the controller as well as the image output from the image processor.

6. The digital photographing apparatus as claimed in claim 1, further comprising:
a storage unit for storing various information necessary for controlling an operation of the digital photographing apparatus, and various information selected based on user selection information.

7. A method for detecting a smear in a digital photographing apparatus, the method comprising the steps of:
searching for conditions in which RGB values of one pixel in a first line and in a last line of an image photographed by the digital photographing apparatus exceed a known value;
calculating representative RGB pixels values as an average value of the RGB pixels values in an x axis of a pixel satisfying the conditions;
calculating an intermediate RGB value on a straight line connecting the representative values if the representative values respectively exist in the first line and the last line;
determining if RGB values of a corresponding pixel exceed the known value as a result of calculation of the pixel value on the straight line; and
determining that a smear has occurred if the RGB values of the corresponding pixel exceed the known value.

8. The method as claimed in claim 7, further comprising a step of:
calculating an intermediate value for each pair if two or more representative values exist in the first line and the last line.

9. A method for correcting a smear in a digital photographing apparatus, the method comprising the steps of:
calculating a width of a pixel area in which all RGB values starting from a first line of an image exceed a known value by using an algorithm which detects a smear in the photographed image;
computing a smear correction area in each line from a representative value in the first line and a representative value in a last line associated with the pixel area;
computing an RGB value associated with a pixel right of and left of the smear correction area; and
altering RGB values of pixels within the correction area by using an average value of the two pixels.

10. The method as claimed in claim 9, wherein the correction area is determined as:
(b−a)/h*y−(R/2)<=x<(b−a)/h*y+(R/2).

11. The method as claimed in claim 9, wherein the step of correcting the image comprises the step of:
performing a linear interpolation method.

12. An apparatus comprising:
a processor in communication with a memory, the processor executing code for performing the steps of:
calculating a width of a pixel area in which all RGB values starting from a first line of an image exceed a known value by using an algorithm which detects a smear in the photographed image;
computing a smear correction area in each line from a representative value in the first line and a representative value in a last line associated with the pixel area; and
computing an RGB value associated with each of two pixels right of and two pixels left of the smear correction area; and altering RGB values of pixels within the correction area by using an average value of the two pixels

13. The apparatus as claimed in claim 12, wherein the correction area is determined as:
(b−a)/h*y−(R/2)<=x<(b−a)/h*y+(R/2).

14. The apparatus as claimed in claim 12, wherein the step of correcting the image comprises the step of:
performing a linear interpolation method.
